(19) United States
(12) Patent Application Publication
(10) Pub. No.: US 2013/0039445 A1
(43) Pub. Date: Feb. 14, 2013

(54) METHOD AND APPARATUS FOR DETERMINING ANALOG BEAM IN HYBRID BEAM-FORMING SYSTEM

(71) Applicant: Duck-Dong Hwang, Yongin-si (KR)

(72) Inventor: Duck-Dong Hwang, Yongin-si (KR)

(73) Assignee: SAMSUNG ELECTRONICS CO., LTD., Suwon-si (KR)

(21) Appl. No.: 13/572,414

(22) Filed: Aug. 10, 2012

(30) Foreign Application Priority Data
Aug. 11, 2011 (KR) 10-2011-0080076

(51) Int. Cl. H04L 27/00

(52) U.S. Cl. 375/316

(57) ABSTRACT

A method and an apparatus determine an analog beam in a digital/analog hybrid beam-forming system. In a method of a reception end, for determining an analog beam in a hybrid beam-forming system, channel information regarding a transmission end is measured. At least one of an analog transmission beam-forming vector and a reception beam-forming vector is determined depending on the measured channel and a digital beam-forming technique in use. Information of the determined transmission beam-forming vector is fed back to the transmission end.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Aug. 11, 2011 and assigned Serial No. 10-2011-0080076, the entire disclosure of which is hereby incorporated by reference.

### TECHNICAL FIELD OF THE INVENTION

The present disclosure relates to a digital/analog hybrid beam-forming system that uses digital beam-forming and analog beam-forming. More particularly, the present disclosure relates to a method and an apparatus for determining an analog beam in a digital/analog hybrid beam-forming system.

### BACKGROUND OF THE INVENTION

The conventional wireless communication system such as a WiMAX, 3GPP LTE, etc. uses a micro wave frequency in a range of about 2 to 10 GHz. Since the conventional wireless communication system uses a relatively long wavelength frequency, it adopts an omindirectional or low-directionality antenna generally.

To meet a request for gradually increasing high transmission rate, a system that uses a frequency in a band of a millimeter wave is considered. The millimeter wave band can provide a very high transmission rate compared to the micro wave. However, the millimeter wave band has a characteristic that attenuation is serious as its frequency band gets high. Therefore, to overcome signal quality deterioration by an attenuation phenomenon, the system that uses the millimeter wave band should support a beam-forming technique.

Particularly, a hybrid beam-forming technique that performs digital beam-forming and analog beam-forming simultaneously may be applied to a wireless communication system that uses the millimeter wave. That is, in the case where digital/analog hybrid beam-forming including a plurality of digital beam-forming portions is used, various gains by a multi-antenna technology may be obtained. However, since lots of antenna elements are used for analog, beam-forming, a channel formed between a transmission end antenna and a reception end antenna has very high complexity and accordingly, an amount of information that should be fed back increases.

Therefore, a beam-forming method requiring a small amount of feedback information while having low complexity in a wireless communication system using digital/analog hybrid beam-forming needs to be proposed.

### SUMMARY OF THE INVENTION

To address the above-discussed deficiencies of the prior art, it is a primary object to provide at least the advantages described below. Accordingly, an aspect of the present disclosure is to provide a method and an apparatus for determining an analog beam in a digital/analog hybrid beam-forming system.

Another aspect of the present disclosure is to provide a method and an apparatus for forming an equivalent Multiple Input Multiple Output (MIMO) channel in order to reduce an amount of feedback channel information in a digital/analog hybrid beam-forming system.

Still another aspect of the present disclosure is to provide a method and an apparatus for determining an analog beam according to an MIMO technique in a digital/analog hybrid beam-forming system.

In accordance with an aspect of the present disclosure, a method of a reception end, for determining an analog beam in a hybrid beam-forming system is provided. The method includes measuring channel information regarding a transmission end, determining at least one of an analog transmission beam-forming vector and a reception beam-forming vector depending on the measured channel and a digital beam-forming technique in use, and feeding back information of the determined transmission beam-forming vector to the transmission end.

In accordance with another aspect of the present disclosure, a method of a transmission end, for determining an analog beam in a hybrid beam-forming system is provided. The method includes transmitting a reference signal for beam training, receiving information of a transmission beam-forming vector from a reception end, and forming an analog transmission beam depending on the received transmission beam-forming vector.

In accordance with still another aspect of the present disclosure, an apparatus of a reception end, for determining an analog beam in a hybrid beam-forming system is provided. The apparatus includes a controller for measuring channel information regarding a transmission end, and determining at least one of an analog transmission beam-forming vector and a reception beam-forming vector depending on the measured channel and a digital beam-forming technique in use, and a feedback unit for feeding back information of the determined transmission beam-forming vector to the transmission end.

In accordance with further another aspect of the present disclosure, an apparatus of a transmission end, for determining an analog beam in a hybrid beam-forming system is provided. The apparatus includes a feedback information receiver for receiving, information of a transmission beam-forming vector from a reception end, and a controller for controlling to transmit a reference signal for beam training and form an analog transmission beam depending on the received transmission beam-faulting vector.

Other aspects, advantages and salient features of the disclosure will become apparent to those skilled in the art from the following detailed description, which, taken in conjunction with the annexed drawings, discloses exemplary embodiments of the disclosure.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a block diagram of a transmission end in a digital/analog hybrid beam-forming system according to an exemplary embodiment of the present disclosure;

FIG. 2 illustrates a block diagram illustrating a reception end in a digital/analog hybrid beam-forming system according to an exemplary embodiment of the present disclosure;

FIG. 3 illustrates a flowchart of a process for operating a transmission end in a digital/analog hybrid beam-forming system according to an exemplary embodiment of the present disclosure; and

FIG. 4 illustrates a flowchart of a process for operating a reception end in a digital/analog hybrid beam-forming system according to an exemplary embodiment of the present disclosure.

Throughout the drawings, like reference numerals will be understood to refer to like parts, components and structures.

### DETAILED DESCRIPTION OF THE INVENTION

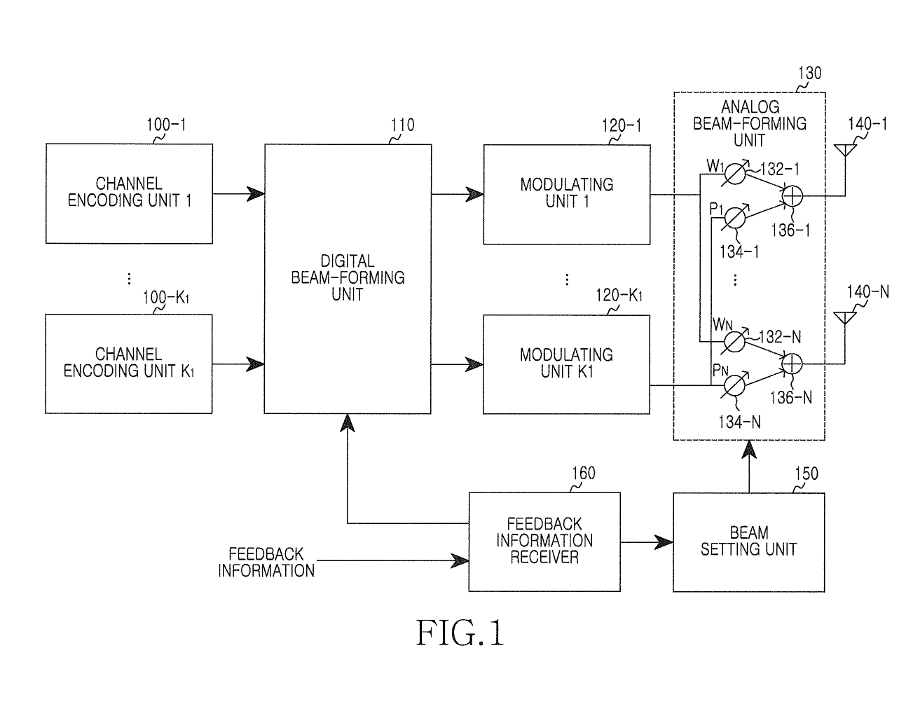

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device. The following description with reference to the accompanying drawings is provided to assist in a comprehensive understanding, of exemplary embodiments of the disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the disclosure. Also, descriptions of well-known functions and constructions are omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of exemplary embodiments of the present disclosure are provided for illustration purpose only and not for the purpose of limiting the disclosure as defined by the appended claims and their equivalents.

The present disclosure relates to a method and an apparatus for determining an analog beam in a digital/analog hybrid beam-forming system.

Exemplary embodiments of the present disclosure provide a method and an apparatus for determining an analog beam in a digital/analog hybrid beam-forming system. Though the present disclosure is described using an Orthogonal Frequency Division Multiplexing (OFDM)/ Orthogonal Frequency Division Multiple Access (OFDMA) wireless communication system as an example, the present disclosure is applicable to a wireless communication system that conforms to other standards in the same way.

FIG. 1 illustrates a block diagram of transmission end in a digital/analog hybrid beam-forming system according to an exemplary embodiment of the present disclosure.

Referring to FIG. 1, the transmission end includes K₁ channel encoding, units 100-1 to 100-K₁, a digital beam forming unit 110, K₁ modulating units 120-1 to 120-K₁, an analog beam-forming unit 130, N antennas 140-1 to 140-N, a beam setting unit 150, and a feedback information receiver 160. That is, the transmission end includes K₁ Radio Frequency (RF) chains and includes N antennas. Here, the RF chain denotes a path for processing a transmission signal from the channel encoding units (100-1 to 100-K₁) to the modulating units (120-1 to 120-K₁).

Each of K₁ channel encoding units 100-1 to 100-K₁ includes a channel encoder and a modulator, thereby encoding a signal to be transmitted to a reception end and then modulating and outputting the signal.

The digital beam-forming unit 110 applies a Multiple Input Multiple Output (MIMO) technique to a signal from the K₁ channel encoding units 100-1 to 100-K₁ to perform digital beam-forming, and then provides the same to each of the K₁ modulating units 120-1 to 120-K₁. At this point, the digital beam-forming unit 110 performs digital beam-forming using short term channel information, that is, channel information measured or fed back at a current point. The digital beam-forming unit 110 performs digital beam-forming on a transmission signal using a space time coding technique, a space multiplexing technique, a closed loop beam-forming technique, etc.

Each of the K₁ modulating units 120-1 to 120-K₁ includes an Inverse Fast Fourier Transform (IFFT) operator and a Digital-to-Analog Converter (DAC), thereby performing IFFT on a digital signal provided from the digital beam-forming unit 110, and then converting the provided signal into an analog signal and outputting the same.

The analog beam-forming unit 130 applies a transmission beam-forming weight to K₁ transmission signals output from the K₁ modulating units 120-1 to 120-K₁ to change phases, thereby forming a beam and outputting the same to N antennas 140-1 to 140-N. That is, the analog beam-forming unit 130 includes a plurality of phase change units 132-1 to 132-N, 134-1 to 134-N and couplers 136-1 to 136-N, thereby separating each of K₁ transmission signals output from K₁ RF chains into N signals, and then changes the phase of each separated transmission signal depending on a predetermined transmission beam-forming vector (w, p), that is, transmission beam-forming weights w₁, . . . , w_{N}, p₁, . . . p_{N}, couples transmission signals whose phases have been changed to form a beam, and then outputs a transmission signal whose beam has been formed to relevant antenna 140-1 to 140-N. For example, a transmission signal output from a K₁-th modulating unit 120-K₁ is divided into N signals, and then the N signals are input to N phase change units 132-1 to 132-N. The phases of the N signals are changed by a predetermined beam-forming vector p, coupled with other transmission signals by N couplers 136-1 to 136-N, and transmitted via N antennas 140-1 to 140-N. At this point, transmission beam-forming weights w₁, . . . w_{N}, p₁, . . . , p_{N} of the phase change units 132-1 to 132-N, 134-1 to 134-N are set depending on information fed back from a reception end, and may change depending on an MIMO technique used by the digital beam-forming unit 110.

To set a transmission beam-forming vector for analog beam-forming, the beam setting unit 150 controls a transmission beam-forming vector of the analog beam-forming unit 130 and controls and processes a function for transmitting a reference signal for beam training. That is, the beam setting unit 150 generates K₁ transmission beam-forming vectors using a codebook stored in advance, applies the generated K₁ transmission beam-forming vectors to the analog beam-forming unit 130, and then controls and processes a function for transmitting a reference signal for beam training formed depending on the transmission beam-forming, vector of the analog beam-forming unit 130 to the reception end. In addition, according to the present disclosure, the beam setting, unit 150 receives information regarding the transmission beam-forming vector from the reception end via the feedback information receiver 160 to set the transmission beam-forming weights of the analog beam-forming unit 130.

Here, an equivalent multiple input/output channel may be formed between a transmission end and a reception end depending on beam setting of the beam setting unit 150. For example, in the example where the number of RF chains in the transmission end and the number of RF chains in the reception end are 2 (K₁=2, K₂=2), respectively, a multiple input/output channel expressed in Equation (1) may be formed.

$$\tilde{H} = [ \begin{matrix}r 1 Hw & r 1 Hp \\ r 2 Hw & r 2 Hp\end{matrix} ] \qquad ( 1 )$$

In Equation (1), \tilde{H} denotes an equivalent channel matrix formed between the transmission end and the reception end, w and p denote transmission beam-forming vectors, r1 and r2 denote reception beam-forming vectors. H denotes an M×N channel matrix formed between antennas of the transmission end and the reception end. That is, the channel matrix H formed between antennas of the transmission end and the reception end may be changed into an equivalent channel matrix \tilde{H} of 2×2 dimension by a transmission beam-forming vector and a reception beam-forming vector selected according to the present disclosure. At this point, the transmission/reception beam-forming vectors are absorbed to \tilde{H}, so that the conventional known MIMO may be immediately applied. Generally, since the number of RF chains of the transmission end is equal to or less than the number of antennas of the transmission end, and the number of RF chains of the reception end is equal to or less than the number of antennas of the reception end, the equivalent channel \tilde{H} has complexity less than that of the channel H.

After that, the beam setting unit 150 informs a controller (not shown) of a signal representing that setting of an analog transmission beam has been completed. Then, the controller (not shown) outputs a transmission signal to K₁ channel encoding units 100-1 to 100-K₁ to control and process a function for transmitting a signal to the reception end via digital/analog, beam-forming. Here, the controller (not shown) serves as a device for controlling and processing an overall operation of the transmission end, and may include the beam setting unit 150.

The feedback information receiver 160 receives information fed back from the reception end to output the information to the beam setting unit 150 or the digital beam-forming forming unit 110. That is, the feedback information receiver 160 provides information regarding the transmission beam-forming vector from the reception end to the beam setting unit 150, and short term channel information from the reception end to the digital beam-forming unit 110. Here, the short term channel information denotes channel information between the transmission/reception ends measured during a threshold time or less.

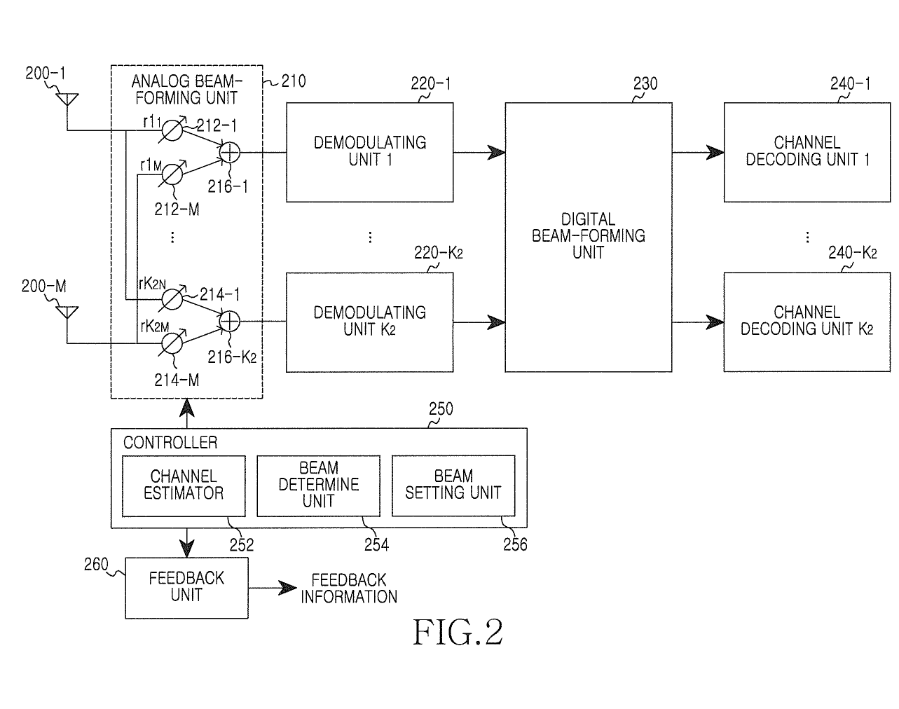

FIG. 2 illustrates a block diagram of a reception end in a digital/analog hybrid beam-forming system according to an exemplary embodiment of the present disclosure.

Referring to FIG. 2, the reception end includes M antennas 200-1 to 200-M, an analog beam-forming unit 210, K₂ demodulating units 220-1 to 220-K₂, a digital beam-forming unit 230, K₂ channel decoding units 240-1 to 240-K₂, a controller 250, and a feedback unit 260. At this point, the controller 250 includes a channel estimator 252, a beam determine unit 254, and a beam setting unit 256. The reception end includes K₂ RF chains and includes the M antennas. Here, the RF chain denotes a path for processing a reception signal from the demodulating units (220-1 to 220-K₂) to channel decoding units (240-1 to 240-N).

First, the controller 250 estimates a channel with a transmission/reception end based on a reception signal from M antennas 200-1 to 200-M, determines a transmission beam-forming vector and a reception beam-forming vector using a channel estimate result to control and process a function for transmitting transmission beam-forming vector information to a transmission end and setting a reception beam-forming vector of the analog beam-forming unit 210.

That is, the channel estimator 252 of the controller 250 estimates a channel formed between a transmission end and a reception end. At this point, the channel estimator 252 estimates long term channel information to provide the same to the beam determine unit 254 for analog beam-forming, and estimates short term channel information to provide the same to the feedback unit 260 for digital beam-forming. When a reference signal for beam training is received from the transmission end, the channel estimator 252 estimates an average value of channel information measured during a threshold time or more, that is, long term channel information to provide the same to the beam determine unit 254. At this point, the channel estimator 252 may estimate an average value of channel information estimated based on a reference signal for beam training received at a current point and reference signals for beam training received at a previous point to provide the same to the beam determine unit 254. In addition, the channel estimator 252 estimates short term channel information from a signal received at a relevant point to provide the same to the feedback unit 260 whenever feedback to the transmission end is needed.

The beam determine unit 254 determines a transmission beam-forming vector and a reception beam-forming vector based on long term channel information provided from the channel estimator 252. Particularly, the beam determine unit 254 determines the transmission beam-forming vector and the reception beam-forming vector that maximize a transmission amount or minimize an error probability depending on a digital beam-forming technique (or MIMO technique) used at the transmission end and the reception end. At this point, in the example where the digital beam-forming unit 230 uses a space time coding technique, the beam determine unit 254 selects a transmission beam-forming vector and a reception beam-forming vector that maximize Frobenius norm ∥\tilde{H}∥_{F} of an equivalent channel \tilde{H}. In contrast, in the example where the digital beam-forming unit 230 uses spatial multiplexing or closed loop beam-forming, the beam determine unit 254 selects a transmission beam-forming vector and a reception beam-forming vector that maximize a determinant |I+\tilde{H}⁺\tilde{H}| of an equivalent channel \tilde{H}. At this point, a method for determining a transmission beam-forming vector and a reception beam-forming vector depending on the MIMO technique may be determined and stored by a designer and an operator. When the transmission beam-forming vector and the reception beam-forming vector are determined, the beam determine unit 254 provides information regarding the transmission beam-forming vector to the beam setting unit 256. Here, the using of long term channel information by the beam determine unit 254 in order to determine the transmission beam-forming vector and the reception beam-forming vector is for reducing an amount of information fed back to the transmission end using a characteristic that an amount of change of channel information depending on time change is small in the example where the long term channel information is used.

The beam setting unit 256 sets reception beam-forming weights r1₁, . . . ,r1_{M},rK₂₁, . . . ,rK_{2M} of the analog beam-forming unit 210 using information regarding a reception beam-forming vector provided from the beam determine unit 254. That is, the beam setting unit 256 sets a phase delay amount of a plurality of phase delays 212-1 to 212-M, 214-1 to 214-M included in the analog beam-forming unit 210.

The feedback unit 260 feeds back information regarding a channel formed between the transmission end and the reception end under control of the controller 250. The feedback unit 260 feeds back information regarding a transmission beam-forming vector (for example, beam index information) provided from the beam determine unit 254 to the transmission end. The feedback unit 260 feeds back short term channel information provided from the channel estimator 252 to the transmission end under control of the controller 250.

The analog, beam-forming unit 210 changes the phase of a reception signal from M antennas 200-1 to 200-M to form a beam, and then provides the same to K₂ demodulating units 220-1 to 220-K₂. That is, the analog beam-forming unit 210 applies reception beam-forming weights r1₁, . . . ,r1_{M},rK₂₁, . . . ,rK_{2M} depending on reception beam-forming vectors r1, . . . ,rK₂ to K₂ signals output from M antennas 200-1 to 200-M and couples them, and then outputs the coupled signals to the K₂ demodulating units 220-1 to 220-K₂. For example, a reception signal from an M-th antenna 200-1 is divided into the number of RF chains, that is, K₂, and then input K₂ phase change units 212-M to 214-M, where the phase of the reception signal is changed depending on predetermined reception beam-forming vectors r1M, . . . ,rK₂M, and coupled with a reception signal from a different antenna by K₂ couplers 216-1 to 216-K2 and provided to K₂ demodulating units 220-1 to 220-K₂.

Each of the K₂ demodulating units 220-1 to 220-K₂ includes a Fast Fourier Transform (FFT) operator and an Analog-to-Digital Converter (ADC), thereby converting an analog signal provided from the analog beam-forming unit 210 into a digital signal, and then performing FFT on the signal and outputting the same.

The digital beam-forming unit 230 applies the MIMO technique to a signal from the K₂ demodulating units 220-1 to 220-K₂ to detect a signal to which the digital beam-forming has been applied, and then provide the same to the K₂ channel demodulating units 240-1 to 240-K₂. At this point, the digital beam-forming unit 230 performs the digital beam-forming using short term channel information, that is, channel information measured or fed back at a current point. The digital beam-forming unit 230 detects a reception signal on which the digital beam-forming has been performed using the space time coding technique, the space multiplexing technique, the closed loop beam-forming technique, etc.

Each of the K₂ channel demodulating units 240-1 to 240-K₂ includes a channel encoder and a demodulator, thereby demodulating a reception signal output from the digital beam-forming unit 230 and decoding and outputting the same.

Then, for convenience in description, description is made on the assumption that the number of antennas of the transmission end is N, the number of antennas of the reception end is M, and the number of RF chains of the transmission end and the number of RF chains of the reception end are 2 (K₁=2, K₂=2), respectively.

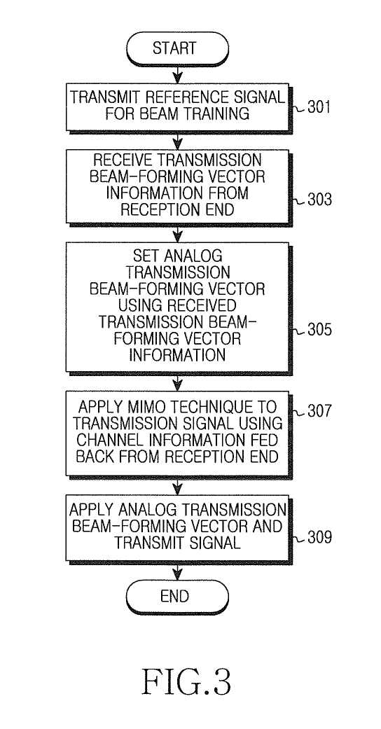

FIG. 3 illustrates a flowchart of a process for operating a transmission end in a digital/analog hybrid beam-forming system according to an exemplary embodiment of the present disclosure.

Referring to FIG. 3, the transmission end transmits a reference signal for beam training in step 301. At this point, the reference signal for beam training is for setting an optimized analog transmission beam-forming vector for signal transmission. The transmission end controls a transmission beam-forming vector applied to the analog beam-forming unit 130 to transmit a reference signal for beam training.

After that, the transmission end receives information regarding a transmission beam-forming vector from a reception end in step 303, and sets an analog transmission beam-forming vector to the analog beam-forming unit 130 using the received information regarding the transmission beam-forming vector in step 305. Here, the information regarding the transmission beam-forming vector may be a beam index representing the transmission beam-forming vector. Here, the transmission beam-forming vector is set by reflecting long term channel information. The transmission beam-forming vector is a vector that maximizes a transmission amount corresponding to the MIMO technique in use or minimizes an error probability. The transmission end may form an equivalent input/output channel expressed by Equation (1) between the transmission end and the reception end by setting a transmission beam-forming vector to the analog beam-forming unit 130.

After that, the transmission end proceeds to step 307 to apply the MIMO technique to a transmission signal using short term channel information fed back from the reception end to perform digital beam-forming, and proceeds to step 309 to apply an analog transmission beam-forming vector to a transmission signal on which the digital beam-forming has been performed and transmit a signal.

After that, the transmission end ends the algorithm according to the present disclosure.

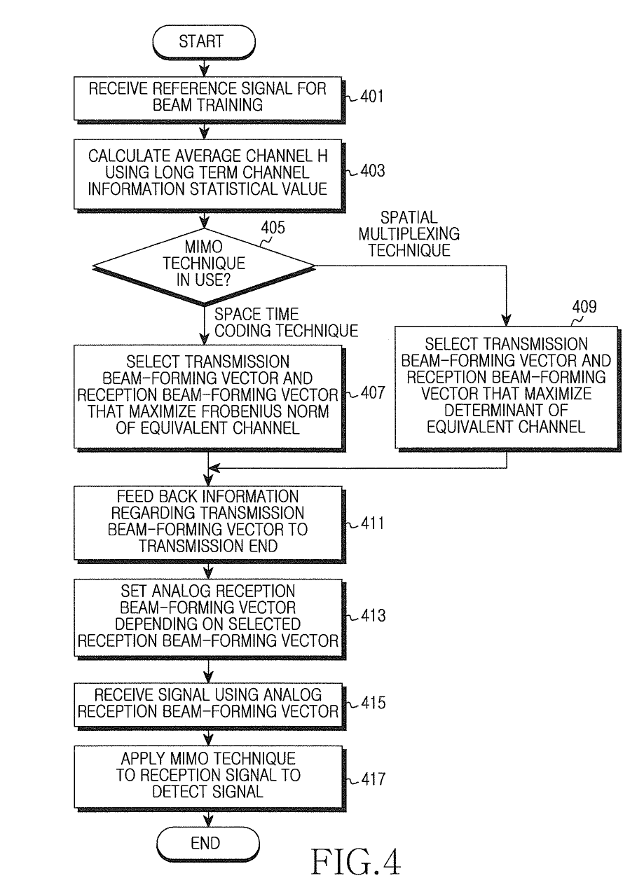

FIG. 4 illustrates a flowchart of a process for operating a reception end in a digital/analog hybrid beam-forming system according to an exemplary embodiment of the present disclosure. Here, for convenience in description, description is made on the assumption that a digital/analog hybrid beam-forming system uses the space time coding technique or the space multiplexing technique for digital beam-forming.

Referring to FIG. 4, the reception end receives a reference signal for beam training from a transmission end in step 401, and proceeds to step 403 to estimate an average value of channel information measured during a threshold time or more, that is, long term channel information. In other words, the reception end calculates an average value of channel information estimated based on a reference signal for beam training received at a current point and channel information estimated based on reference signals for beam training received at a previous point to estimate long term channel information.

After that, the reception end proceeds to step 405 to determine a digital beam-forming technique in use, that is, the MIMO technique in step 403. If the reception end determines that the space time coding technology is used, the reception end proceeds to step 407 to select a transmission beam-forming vector and a reception beam-forming vector that maximize Frobenius norm ∥\tilde{H}∥_{F} of an equivalent channel \tilde{H} to maximize a transmission amount or minimize an error probability. In contrast, if the reception end determines that the spatial multiplexing technique is used, the reception end proceeds to step 409 to select a transmission beam-forming vector and a reception beam-forming, vector that maximize the determinant of an equivalent channel \tilde{H} to maximize a transmission amount or minimize an error probability. Here, using long term channel information to determine the transmission beam-forming vector and the reception beam-forming vector is for reducing an amount of information fed back to the transmission end using a characteristic that an amount of change of channel information depending on time change is small in the example where the long term channel information is used.

After that, the reception end feeds back information regarding a transmission beam-forming vector (for example, beam index) to the transmission end in step 411 and proceeds to step 413 to set analog reception beam-forming weights r1₁, . . . ,r1_{M},rK₂₁, . . . ,rK_{2M} of the phase delays 212-1 to 212-M, 214-1 to 214-M included in the analog beam-forming unit 210 of the reception end depending on a reception beam-forming vector.

After that, the reception end performs analog beam-forming depending on an analog reception beam-forming vector to receive a signal from the transmission end in step 415 and proceeds to step 417 to apply the MIMO technique to a reception signal and perform digital beam-forming and detect a signal, and ends the algorithm according to the present disclosure.

Though description of FIG. 4 has been made on the assumption that a digital/analog hybrid beam-forming system uses the space time coding technique or the spatial multiplexing technique for digital beam-forming, the present disclosure may be applicable to a different MIMO technique known to the conventional art in the same way. That is, the reception end may select a transmission/reception beam-forming vector for maximizing a transmission amount or minimizing an error probability depending on an MIMO technique in use. Of course, a method for determining each MIMO technique and a transmission/reception beam-forming vector, that is, whether to determine a transmission/reception beam-forming vector that maximizes Frobenius norm of an equivalent channel \tilde{H} or whether to determine a transmission/reception beam-forming vector that maximizes a determinant of an equivalent channel \tilde{H} may be set in advance by a designer or an operator, or a well-known conventional method may be used.

As described above, according to the present disclosure, a digital/analog hybrid beam-forming system sets an analog beam-forming vector for forming an equivalent multiple input/output channel between a transmission end and a reception end and applies the well-known conventional MIMO technique using an equivalent multiple input/output channel of low complexity, thereby reducing an amount of feedback information.

According to the present disclosure, a digital/analog hybrid beam-forming system determines an analog beam depending on an MIMO technique to form an equivalent MIMO channel between a transmission end and a reception end, thereby reducing an amount of feedback information.

Although the disclosure has been shown and described with reference to certain exemplary embodiments thereof, it will be understood by those skilled in the art that various changes in form and details may be made therein without departing from the spirit and scope of the disclosure as defined by the appended claims and their equivalents. Therefore, the scope of the present disclosure should not be limited to the above-described embodiments but should be determined by not only the appended claims but also the equivalents thereof.

What is claimed is:

1. A method of operating a reception end, for determining an analog beam in a hybrid beam-forming system, the method comprising:
measuring channel information regarding a transmission end;
determining at least one of an analog transmission beam-forming vector and a reception beam-forming vector depending on the measured channel and a digital beam-forming technique in use; and
feeding back information of the determined beam-forming vector to the transmission end.

2. The method of claim 1, wherein determining the at least one of the analog transmission beam-forming vector and the reception beam-forming vector comprises selecting a beam-forming vector meeting at least one of maximization of a transmission amount and minimization of an error probability in the digital beam-forming technique in use.

3. The method of claim 2, wherein selecting the beam-forming vector comprises, when the digital beam-forming technique in use is a space time coding technique, selecting a transmission beam-forming vector and a reception beam-forming vector that maximize a Frobenius norm of an equivalent channel.

4. The method of claim 2, wherein selecting the beam-forming vector comprises, when the digital beam-forming technique in use is one of a spatial multiplexing technique and a closed loop beam-forming technique, selecting a transmission beam-forming vector and a reception beam-forming vector that maximize a determinant of an equivalent channel.

5. The method of claim 1, wherein determining the at least one of the analog transmission beam-forming vector and the reception beam-forming vector depending on the measured channel and the digital beam-forming technique in use comprises determining an analog transmission beam-forming vector and a reception beam-forming vector using long term channel information representing an average value of a channel during at least a threshold time.

6. The method of claim 5, further comprising receiving a reference signal for beam training from the transmission end,
wherein the long term channel information is measured based on the reference signal for beam training.

7. The method of claim 5, further comprising, after the determining of the at least one of the analog transmission beam-forming vector and the reception beam-forming vector, feeding back short term channel information representing channel information of a relevant point.

8. The method of claim 1, further comprising forming an analog reception beam depending on the determined reception beam-forming vector.

9. A method of operating a transmission end, for determining an analog beam in a hybrid beam-forming system, the method comprising:
transmitting a reference signal for beam training;
receiving information of a transmission beam-foaming vector from a reception end; and
forming an analog transmission beam depending on the received transmission beam-forming vector.

10. The method of claim 9, further comprising, after the forming of the analog transmission beam, performing digital beam-forming for a transmission signal using short term channel information fed back from the reception end.

11. An apparatus in a reception end, configured to determine an analog beam in a hybrid beam-forming system, the apparatus comprising:
a controller configured to measure channel information regarding a transmission end, and determine at least one of an analog transmission beam-forming vector and a reception beam-forming vector depending on the measured channel and a digital beam-forming technique in use; and
a feedback unit configured to feed back information of the determined beam-forming vector to the transmission end.

12. The apparatus of claim 11, wherein the controller is configured to select a beam-forming vector meeting at least one of maximization of a transmission amount and minimization of an error probability in the digital beam-forming technique in use.

13. The apparatus of claim 12, wherein when the digital beam-forming technique in use is a space time coding technique, the controller is configured to select a transmission beam-forming vector and a reception beam-forming vector that maximize a Frobenius norm of an equivalent channel.

14. The apparatus of claim 12, wherein when the digital beam-forming technique in use is one of a spatial multiplexing technique and a closed loop beam-forming technique, the controller is configured to select a transmission beam-forming vector and a reception beam-forming vector that maximize a determinant of an equivalent channel.

15. The apparatus of claim 11, wherein the controller is configured to determine an analog transmission beam-forming vector and a reception beam-forming vector using long term channel information representing an average value of a channel during at least a threshold time.

16. The apparatus of claim 15, wherein the controller is configured to measure the long term channel information based on a reference signal for beam training received from the transmission end.

17. The apparatus of claim 15, wherein after determining at least one of the analog transmission beam-forming vector and the reception beam-forming vector, the controller is configured to control the feedback unit to feed back short term channel information representing channel information of a relevant point.

18. The apparatus of claim 11, further comprising an analog beam-forming unit configured to form an analog reception beam depending on the reception beam-forming vector determined by the controller.

19. An apparatus in a transmission end, configured to determine an analog beam in a hybrid beam-forming system, the apparatus comprising:
a feedback information receiver configured to receive information of a transmission beam-forming vector from a reception end; and
a controller configured to control a transmitter to transmit a reference signal for beam training and form an analog transmission beam depending on the received transmission beam-forming vector.

20. The apparatus of claim 19, wherein after the analog transmission beam is formed, the controller is configured to control to perform digital beam-forming for a transmission signal using short term channel information fed back from the reception end.
